(19) United States
(12) Patent Application Publication
(10) Pub. No.: US 2009/0051601 A1
(43) Pub. Date: Feb. 26, 2009

(54) ANTENNA DEVICE FOR PORTABLE TERMINAL

(76) Inventors: Ju-Hyang Lee, Suwon-si (KR); Joong Hee Lee, Seongnam-si (KR)

Correspondence Address: CHA & REITER, LLC, 210 ROUTE 4 EAST STE 103, PARAMUS, NJ, 07652, US

(21) Appl. No.: 12/196,344

(22) Filed: Aug. 22, 2008

(30) Foreign Application Priority Data
Aug. 23, 2007 (KR) 2007-0085124

(51) Int. Cl. H01Q 1/38

(52) U.S. Cl. 343/700 MS

(57) ABSTRACT

An antenna includes a dielectric substrate on which a via hole is formed; a radiation patch attached onto the dielectric substrate and connected to the via hole; a ring-shaped first radiation pattern formed on the dielectric substrate and has a part connected to the radiation patch; and a ring-shaped second radiation pattern formed on the dielectric substrate and has a part connected to the radiation patch. The radiation patch, the first radiation pattern and the second radiation pattern each receive a feeding through the via hole, and operate in different frequency bands. The antenna device for a portable terminal has the radiation patch and the first and second radiation patterns, which resonate in different frequency bands, so that it can operate in various frequency bands.

### CLAIM OF PRIORITY

This application claims the benefit of an earlier Patent Application filed in the Korean Intellectual Property Office on Aug. 23, 2007 and assigned Serial No. 2007-85124, the disclosures of which are incorporated herein by reference.

### BACKGROUND OF THE INVENTION

1. Field of the Invention

The present invention relates generally to an antenna device, and in particular, to an antenna device for a portable terminal operating in various frequency bands.

2. Description of the Related Art

In general, an antenna provides a function of radiating and receiving radio waves to support a radio transmission/reception function. The antenna device can be used in various fields including portable devices, such as radiotelegraph, radio set, mobile phone, etc., as well as communication facilities, such as broadcast relay, mobile communication base station, etc.

With the popularization of services such as voice call and Short Message Service (SMS) based on a portable terminal and recent advent of multimedia services based on the mobile communication service, for example, Video on Demand (VOD) and Digital Multimedia Broadcasting (DMB), an antenna requires higher performance. That is, compared with the traditional voice call and SMS, transmission of moving pictures requires a broader bandwidth and a higher transfer rate.

As mobile communication services based on the portable terminal are diversified, transceivers based on short-range wireless communication are provided as auxiliary devices for the portable terminal to offer convenience to the user, for example, an ear set connected to the portable terminal wirelessly for voice call and music listening. A short-range wireless communication protocol used for this purpose includes Bluetooth. In this case, both the antenna device coinciding with the unique frequency band assigned to the common carrier and another antenna device for a short-range wireless communication device. However, given potability of the portable terminal, there are many difficulties in mounting the multiple antenna devices operating in different frequency bands.

In addition, since the mobile communication services are different in their frequency bands according to nations, regions and/or common carriers, the user may not get the mobile communication services being provided through different frequency bands with the portable terminal having only one mobile communication service-dedicated antenna installed therein. In order to allow the user to benefit mobile communication services based on different frequency bands, independent antenna devices operating in their frequency bands must be mounted in the portable terminal, but this causes an increase in the manufacturing cost and inconveniences the user to carry even the antenna device that he/she does not actually use.

Recently, with the trend towards miniaturization of the portable terminal, it is a common practice to embed the antenna devices in the portable terminal. As seen above, there are many difficulties in embedding the antenna devices in the portable terminal so that the user can enjoy all the mobile communication services being provided through different frequency bands, or in securing the antenna device for short-range wireless communication.

### SUMMARY OF THE INVENTION

An aspect of the present invention is to address at least the problems and/or disadvantages and to provide at least the advantages described below. Accordingly, an aspect of the present invention is to provide an antenna device for a portable terminal, which can operate in various frequency bands with use of one antenna.

Another aspect of the present invention is to provide an antenna device which can operate in various frequency bands and reduce its space occupied in a portable terminal, thereby improving the miniaturization efforts in the portable terminal.

Further another aspect of the present invention is to provide an antenna device for a portable terminal, which operates in various frequency bands so that it is compatible even in the nations and/or regions where mobile communication services are provided in different frequency bands.

Still another aspect of the present invention is to provide an antenna device for a portable terminal, which operates in various frequency bands so that a terminal manufacturer can reduce the unnecessary time and expenses required for redesigning the antenna device.

According to one aspect of the present invention, an antenna device for a portable terminal includes: a dielectric substrate on which a via hole is formed; a radiation patch which is attached onto the dielectric substrate and connected to the via hole; a ring-shaped first radiation pattern which is formed on the dielectric substrate and has a part connected to the radiation patch; and a ring-shaped second radiation pattern which is formed on the dielectric substrate and has a part connected to the radiation patch. The radiation patch, the first radiation pattern and the second radiation pattern each receive a feeding through the via hole, and operate in different frequency bands.

As the radiation patch, the first radiation pattern and the second radiation pattern have different resonant frequencies according to their sizes, they can operate in various frequency bands, making it possible for a user to enjoy the mobile communication services provided through different frequency bands using only one portable terminal.

Preferably, the first radiation pattern is disposed to enclose the radiation patch, and the second radiation pattern is disposed to enclose the first radiation pattern, contributing to minimization of their sizes.

Preferably, the antenna device further includes a meander-line radiation pattern connected to the second radiation pattern to variably set a resonant frequency of the second radiation pattern, contributing to a reduction in size of the second radiation pattern.

Preferably, the antenna device includes radiation substances, i.e., the radiation patch and the first and second radiation patterns, which resonate in different frequency bands, so that it can operate in various frequency bands.

Preferably, the antenna device further includes a meander-line radiation pattern connected to the second radiation pattern to reduce a size of the second radiation pattern, contributing to miniaturization of the antenna device.

Preferably, the antenna device includes radiation substances that resonate in different frequency bands, so that it is compatible even in the nations and/or regions where mobile communication services are provided in different frequency bands, and the terminal manufacturers can reduce the time and cost required for designing and manufacturing the antenna device since there is no need to redesign the antenna device according to the frequency bands of the mobile communication services provided in the regions where the portable terminals will be commercially available.

### BRIEF DESCRIPTION OF THE DRAWINGS

The above and other aspects, features and advantages of the present invention will become more apparent from the following detailed description when taken in conjunction with the accompanying drawings in which:

FIG. 1 is a side view illustrating a structure of an antenna device for a portable terminal according to an embodiment of the present invention;

FIG. 2 is a top view illustrating a structure of the antenna device shown in FIG. 1;

FIG. 3 is a top view illustrating another structure of the antenna device shown in FIG. 1;

FIG. 4 is a graph illustrating radiation characteristics of a radiation patch of the antenna device shown in FIG. 3;

FIG. 5 is a graph illustrating radiation characteristics of a first radiation pattern of the antenna device shown in FIG. 3;

FIG. 6 is a graph illustrating radiation characteristics of a second radiation pattern of the antenna device shown in FIG. 3; and

FIG. 7 is a graph illustrating a radiation characteristic of the antenna device shown in FIG. 3.

### DETAILED DESCRIPTION OF THE INVENTION

Now, embodiments of the present invention will now be described in detail with reference to the annexed drawings. For the purposes of clarity and simplicity, a detailed description of known functions and configurations incorporated herein has been omitted for conciseness.

In forming radiation substances on a dielectric substrate, an antenna device for a portable terminal according to the teachings of the present invention includes a radiation patch, a first radiation pattern, and a second radiation pattern, which operate in different frequency bands, and when necessary, can adjust the size and operating frequency of the second radiation pattern using a meander-line radiation pattern coupled to the second radiation pattern.

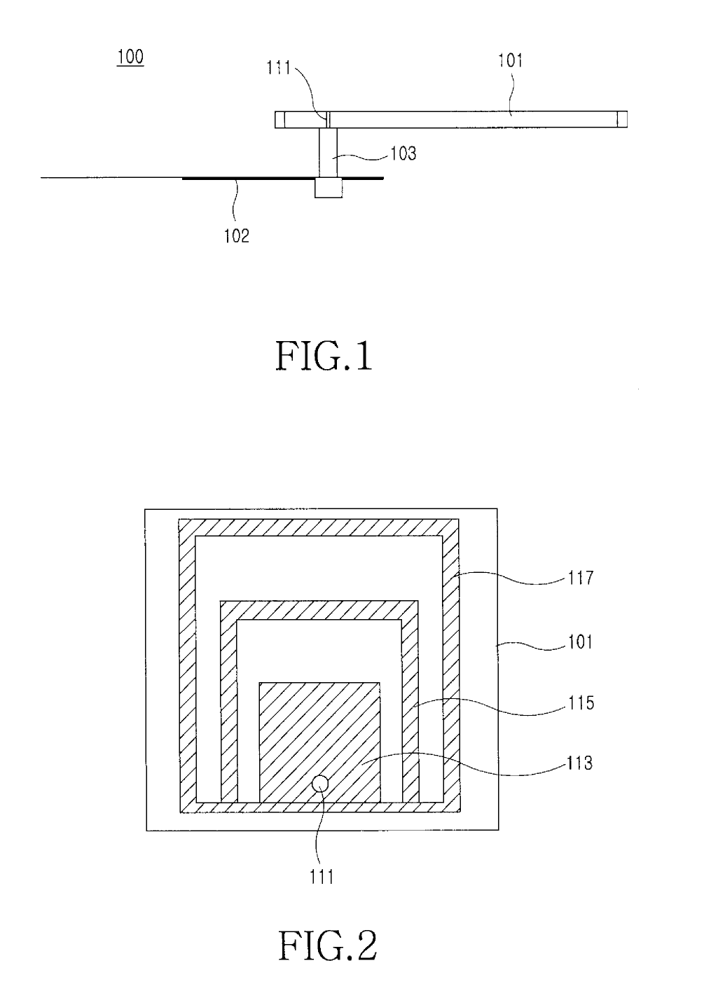

Referring to FIGS. 1 and 2, an antenna device 100 of a portable terminal according to an embodiment of the present invention includes radiation substances formed on a dielectric substrate bland provides a feeding to the radiation substances through one via hole 111.

The radiation substances include a radiation patch 113, a ring-shaped first radiation pattern 115, and a ring-shaped second radiation pattern 117, and the square-shaped radiation patch 113 is attached to the dielectric substrate 101. The first radiation pattern 115 and the second radiation pattern 117 each have a squared-ring shape. The first radiation pattern 115 is disposed to enclose the radiation patch 113, and the second radiation pattern 117 is disposed to enclose the first radiation pattern 115. In this case, the first and second radiation patterns 115 and 117 each have their at least one side connected to the radiation patch 113, and the via hole 111 formed on the dielectric substrate 101 is connected to the radiation patch 113. Therefore, the radiation patch 113, the first radiation pattern 115 and the second radiation pattern 117 each receive a common feeding through the via hole 111.

The antenna device 100 receives a feeding provided from a circuit substrate 102 of the portable terminal, and a ground pattern is formed on the circuit substrate 102. A coaxial cable 103 extends from the circuit substrate 102 so that an inner conductor of the coaxial cable 103 is connected to the via hole 111 and an outer conductor of the coaxial cable 103 is connected to the ground pattern to provide a ground connection of the dielectric substrate 101. Here, an air gap or another dielectric substrate can intervene between the dielectric substrate 101 and the circuit substrate 102.

Although the antenna device 100 is connected herein to the circuit substrate 102 using the coaxial cable 103, by way of example, it would be obvious to those skilled in the art that the dielectric substrate 101 can be directly mounted on the circuit substrate 102 to provide a feeding from the antenna device 100.

Since the frequency is generally in inverse proportion to the size of the radiation substances, the radiation patch 113 among the radiation substances operates in the highest frequency band and the second radiation pattern 117 operates in the lowest frequency band.

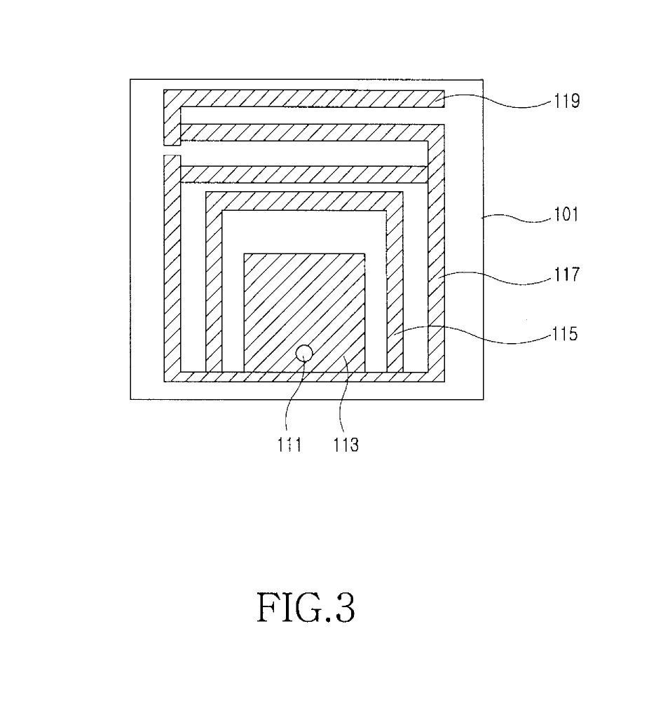

FIG. 3 illustrates an example in which a part of the second radiation pattern 117 is modified and a meander-line radiation pattern 119 connected to the second radiation pattern 117 is formed. That is, the second radiation pattern 117 shown in FIG. 3 is substantially equal to the second radiation pattern 117 shown in FIG. 2, but is different in that it is reduced in its size and also connected to the meander-line radiation pattern 119.

If the meander-line radiation pattern 119 connected to the second radiation pattern 117 is formed on the dielectric substrate 101 as illustrated in FIG. 3, the size (to be specific, the length) of the second radiation pattern 117 increases, thus making it possible to decrease the operating frequency of the second radiation pattern 117. That is, the size of the second radiation pattern 117 is increased by the meander-line radiation pattern 119.

If the second radiation pattern 117 shown in FIG. 2 operates at a particular frequency, for example, in a first frequency band, since the second radiation pattern 117 shown in FIG. 3 has a smaller size than the second radiation pattern 117 shown in FIG. 2 and its actual radiation substance's length can be maintained equal to that of the second radiation pattern 117 of FIG. 2 by means of the meander-line radiation pattern 119, so that even the second radiation pattern 117 of FIG. 3, connected to the meander-line radiation pattern 119, operates in the first frequency band.

However, by connecting the meander-line radiation pattern 119 to the second radiation pattern 117, it is possible to decrease the operating frequency of the second radiation pattern 117, or reduce the size of the second radiation pattern 117 while maintaining the same operating frequency. In this case, it is possible to adjust the operating frequency of the second radiation pattern 117 by adjusting the size of the second radiation pattern 117, and the operating frequency can be set depending on the line width, inter-line interval and length of the meander-line radiation pattern 119. That is, the operating frequency of the second radiation pattern 117 is easier to adjust than the operating frequency of the radiation patch 113 and/or the first radiation pattern 115.

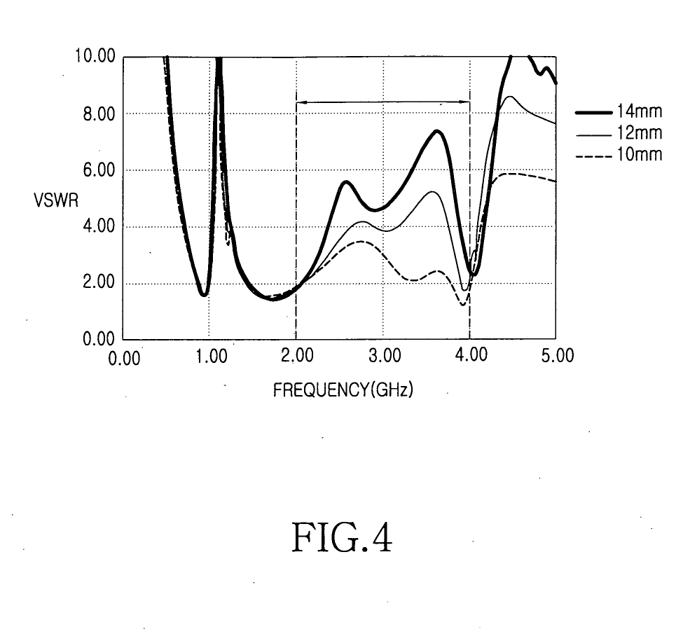

FIGS. 4 through 6 are graphs illustrating measured radiation characteristics (to be specific, Voltage Standing Wave Ratios (VSWRs)) of the radiation patch 113, the first radiation pattern 115 and the second radiation pattern 117, respectively.

FIG. 4 is a graph illustrating VSWR values with respect to frequencies, measured when the radiation patch 113 is made in a square shape and a length of its one side changes to 14 mm, 12 mm and 10 mm, on condition that the first and second radiation patterns 115 and 117 maintain their sizes. It can be appreciated from FIG. 4 that the VSWR values significantly change according to the size of the radiation patch 113 in a 2.1˜4-GHz band, but the VSWR values are maintained almost constant in the frequency band other than the 2.1˜4-GHz band even though the size of the radiation patch 113 changes. Therefore, it is possible to set the operating frequency in the 2.1˜4-GHz band by adjusting the size of the radiation patch 113.

In this case, the VSWR values available in the mobile communication service should satisfy a condition of VSWR≦3, and it can be appreciated from the measurement result on the VSWR values that the radiation patch 113, when it is made in a square such that its one side is 10 mm long, can be used for the mobile communication service provided through a 2.1˜2.5-GHz frequency band.

Meanwhile, although a change in VSWR value with respect to the change in size of the radiation patch 113 is significant even in the frequency band exceeding 4.3 GHz, the corresponding frequency band is not used as the commercial frequency band, and is unsuitable to be used for the mobile communication service since its VSWR value exceeds 3.

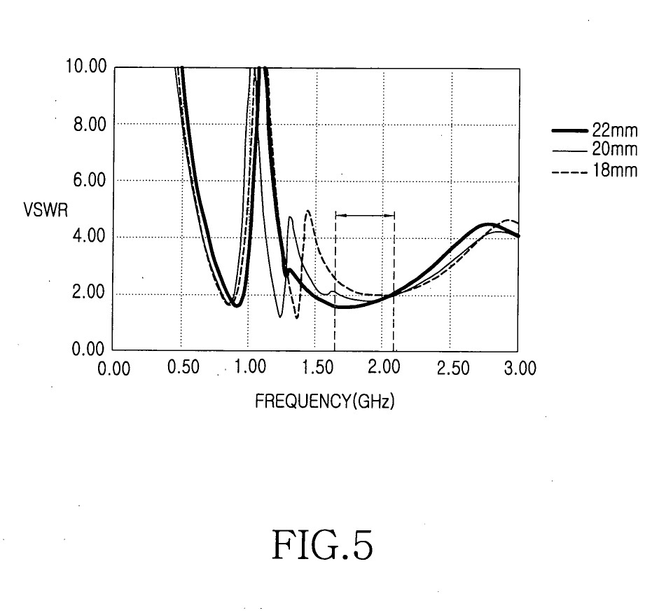

FIG. 5 is a graph illustrating VSWR values with respect to frequencies, measured when the first radiation pattern 115 is made in a squared-ring shape and a length of its one side changes to 22 mm, 20 mm and 18 mm, on condition that the radiation patch 113 and the second radiation pattern 117 maintain their sizes. It can be appreciated from FIG. 5 that in a 1.7˜2.1-GHz band, a change in VSWR value with respect to the change in size of the first radiation pattern 115 is noticeable, and a change in VSWR value with respect to the change in its operating frequency is insignificant. In addition, it can be noted that in the 1.7˜2.1-GHz band, as the VSWR values are all measured below 3, the first radiation patterns 115 having squared-ring shapes, lengths of one sides of which are 22 mm, 20 mm and 18 mm, respectively, can be used for the mobile communication services being provided through the 1.7˜2.1-GHz frequency band.

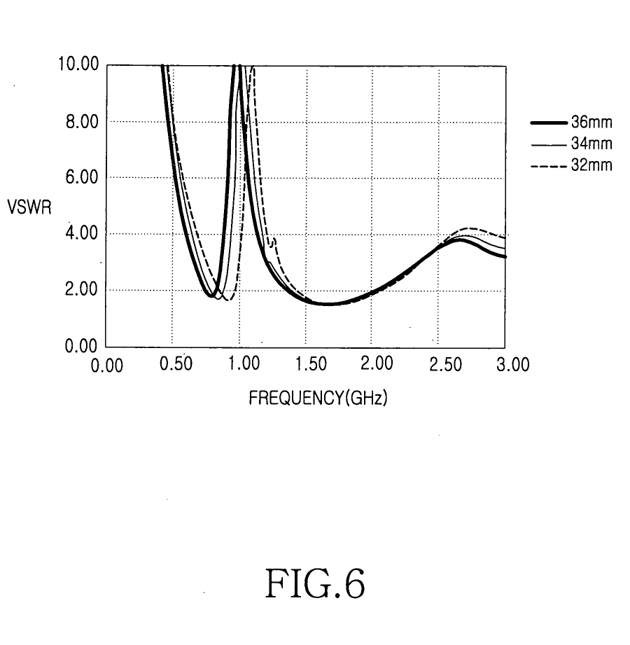

FIG. 6 is a graph illustrating VSWR values with respect to frequencies, measured when the second radiation pattern 117 is made in a squared-ring shape, and the length of its one side changes to 36 mm, 34 mm and 32 mm, on condition that the radiation patch 113 and the first radiation pattern 115 maintain their sizes. It can be appreciated from FIG. 6 that in a 800˜950-MHz band, a change in VSWR value with respect to the change in size of the second radiation pattern 117 is noticeable and a change in VSWR value with respect to the change in its operating frequency is insignificant, and in the corresponding frequency band, the VSWR values are all measured below 3. That is, it can be noted that the second radiation patterns 117 having squared-ring shapes, lengths of one sides of which are 36 mm, 34 mm and 32 mm, respectively, can be used for the mobile communication services being provided through the 800˜950-MHz frequency band.

In conclusion, even though only one antenna device 100 including the radiation patch 113, the first radiation pattern 115 and the second radiation pattern 117 is mounted in the portable terminal, the user can enjoy the mobile communication services being provided through frequencies in all of the 2.1˜2.5-GHz band, the 1.7˜2.1-GHz band and the 800˜950-MHz band. If the antenna device 100 is installed in a device requiring miniaturization such as the portable terminal, it is possible to miniaturize the second radiation pattern 117 using the meander-line antenna pattern, thus further contributing to miniaturization of the antenna device 100.

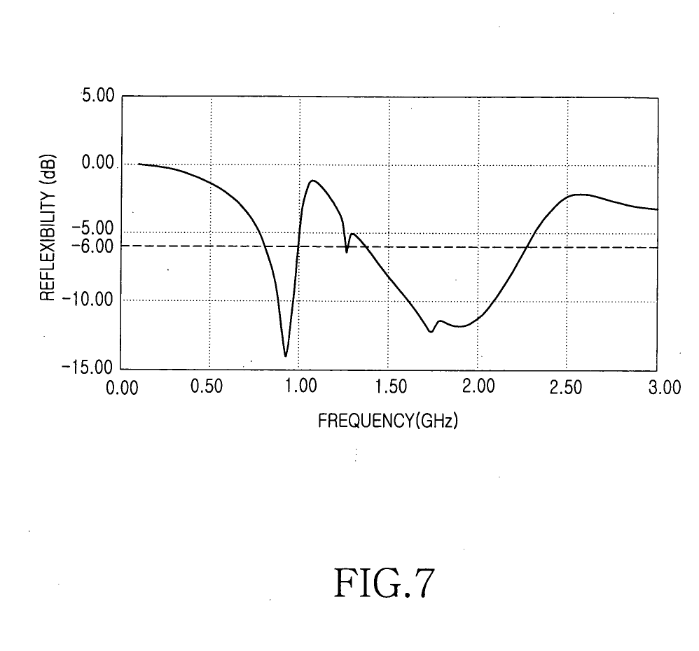

FIG. 7 is a graph illustrating a measured radiation characteristic (to be specific, reflexibility) of the antenna device 100 including the radiation patch 113 and the first and second radiation patterns 115 and 117. The term ‘reflexibility’ as used herein refers to a ratio in which radiation power of a transmission signal provided to the antenna device 100 is reflected after failing to be radiated through the antenna device 100, and the reflexibility of the antenna device 100 to be applied for the mobile communication services should satisfy a condition of reflexibility <−6 dB. According to the graph, the frequency bands satisfying the reflexibility condition of the antenna device 100 include a 0.8˜1-GHz band and a 1.4˜2.5-GHz band, and the mobile communication services provided in the corresponding frequency bands can be transmitted/received through the one antenna device 100.

Regarding the frequency bands for mobile communication schemes, the CDMA/TDMA/GSM communication scheme is provided in a 824˜924-MHz band, the EGSM communication scheme is provided in a 880˜960-MHz band, the GPS scheme is provided in a 1575-MHz band, the DCS scheme is provided in a 1710˜1880-MHz band, the PCS scheme is provided in a 1860˜1990-MHz band, and the UMTS scheme is provided in a 1920˜2170-MHz band. In addition, Bluetooth, one of the short-range wireless communication protocols, is provided through frequencies in a 2400˜2500-MHz band. Since the antenna device 100 according to the present invention can be used for the mobile communication services, which provides services in the 0.8˜1-GHz band and 1.4˜2.5-GHz band, the user can enjoy all mobile communication services based on the above-stated communication schemes using the portable terminal in which only one antenna device 100 is mounted. However, it would be obvious to those skilled in the art that the radiation patch 113, the first radiation pattern 115 and the second radiation pattern 117 may require a change in their sizes to be suitable for the regions where the portable terminals will be put on sale, or for the communication schemes that the portable terminals will mainly use. Meanwhile, when the second radiation pattern 117 is formed in a squared-ring shape, a length of one size of which is 32˜36 mm long, the large size may be an obstacle to miniaturization of the antenna device 100. In this case, therefore, it is possible to minimize the size of the second radiation pattern 117 using the meander-line radiation pattern 119, thus contributing to miniaturization of the antenna device 100.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An antenna device for a portable terminal, comprising:
a dielectric substrate on which a via hole is formed;
a radiation patch coupled to the dielectric substrate and the via hole;
a ring-shaped first radiation pattern formed on the dielectric substrate and having a portion thereof coupled to the radiation patch; and
a ring-shaped second radiation pattern formed on the dielectric substrate and having a portion thereof coupled to the radiation patch,
wherein the radiation patch, the first radiation pattern, and the second radiation pattern each receive a feeding through the via hole, and operate in different frequency bands.

2. The antenna device of claim 1, further comprising a meander-line radiation pattern formed on the dielectric substrate and coupled to the second radiation pattern.

3. The antenna device of claim 2, wherein an operating frequency of the second radiation pattern is selectively adjusted depending on line width, inter-line interval and length of the meander-line radiation pattern.

4. The antenna device of claim 1, wherein the first and second radiation patterns each have a squared-ring shape.

5. The antenna device of claim 1, wherein the first radiation pattern is disposed to enclose the radiation patch, and the second radiation pattern is disposed to enclose the first radiation pattern.

6. The antenna device of claim 5, wherein the first and second radiation patterns each have a squared-ring shape.

7. The antenna device of claim 5, further comprising a meander-line radiation pattern formed on the dielectric substrate and coupled to the second radiation pattern.

8. The antenna device of claim 1, wherein the dielectric substrate is coupled to a circuit substrate on which a ground pattern is formed.

9. The antenna device of claim 8, wherein a coaxial cable extending from the circuit substrate is coupled to the via hole.

10. The antenna device of claim 9, wherein an air gap or another dielectric substrate intervenes between the circuit substrate and the dielectric substrate.

11. The antenna device of claim 8, wherein the dielectric substrate is mounted on the circuit substrate and receives a feeding provided through the via hole.

12. The antenna device of claim 1, wherein an operating frequency of the second radiation pattern is selectively adjusted using a meander-line radiation pattern.

13. The antenna device of claim 1 wherein an operating frequency of the second radiation pattern is selectively adjusted by adjusting the size of the second radiation pattern.
